(19) United States
(12) Patent Application Publication
(10) Pub. No.: US 2010/0154174 A1
(43) Pub. Date: Jun. 24, 2010

(54) Carriage with a drive device and separation device

(75) Inventors: Gregor Haab, Allenwinden (CH); Marco Odermatt, Stans (CH)

Correspondence Address: OLIFF & BERRIDGE, PLC, P.O. BOX 320850, ALEXANDRIA, VA, 22320-4850, US

(73) Assignee: HAWA AG, Mettmenstetten (CH)

(21) Appl. No.: 12/591,789

(22) Filed: Dec. 1, 2009

(30) Foreign Application Priority Data
Dec. 22, 2008 (EP) 08 172 651.5

(51) Int. Cl. E05D 15/06; E05F 15/14

(52) U.S. Cl. 16/96 R; 16/107; 49/358

(57) ABSTRACT

The carriage provided for a separation device comprises a carriage body serving to hold a separation element, which carriage body comprises at least one running wheel, which can be moved on a rail, and a drive device made up of an electric motor and a gearing, which drive device is coupled to a first drive element, by means of which a force can be transferred to the rail and the carriage can be driven. According to the invention the drive device is coupled to at least one second drive element, by means of which the separation element held so as to be rotatable can be driven. Using the inventive carriage, separation elements which are separate or connected to each other in a jointed way can be advantageously displaced and/or rotated.

The invention relates to a carriage with a drive device and to a separation device with such a carriage, which is guided in a rail and is connected to at least one separation element, such as a sliding door.

In order to separate or form areas or to close off room or window openings, separation elements are often used such as sliding doors, which are fixed to carriages, which can be displaced along a rail and are possibly mounted so as to be rotatable. Such sliding doors are for example made from transparent glass, wood or metal.

A generic carriage is known from [1], EP 1 916 370 A1, which is used to drive a separation element, which can be displaced linearly and around curves and is optionally rotatable and parkable. This carriage, which is guided by means of two running wheels on a running surface of a rail, comprises a drive shaft driven by means of an electric motor and a gearing, which drive shaft has a cog wheel, which engages in a cog belt connected to the rail and rolls on said cog belt, thereby displacing the carriage along the rail. The separation element is preferably held by the carriage so as to be rotatable by means of a load shaft, thereby also allowing curved displacement.

It is shown in [2], WO 97/49885 that guide rails divided into two are used for the displacement of sliding doors into a parking area, which guide rails comprise a branch in the station area, from which branch a straight and a curved rail element are continued. The sliding doors are thereby each hung on two carriages guided in the rail, one of these carriages travelling into the straight rail element and the other into the curved rail element. The sliding doors are thereby rotated by 90° and stacked lying against each other for example against a wall. A particular rail system is thus required for the rotation of the sliding doors, which rail system is optionally to be adapted individually to the local conditions.

A fitting for folding sliding shutters is known from [3], product catalogue of HAWA A G, “Baubeschläge für Faltschiebeläden” [“Structural fittings for folding sliding shutters”], 2006, page 36, which fitting has an even or uneven number of wings, which are installed for example on a window front or on the outer side of a balcony. The wing elements of the folding assemblies are connected in a rotatable way to each other by means of hinges. Such a folding assembly can be pushed laterally against a wall or used free standing as a light shield or wind shield. The displacement, opening or folding of the folding assembly, is realised without an additional rail element through manual intervention. The wing elements are thereby normally rotated at unequal speeds with the result that irregular folding processes arise in dependence upon the manual intervention.

It is thus an object of the present invention to create a carriage with a drive device and a separation device with such a carriage, by means of which separation elements can be moved more advantageously.

The carriage shall require little space such that said carriage, in the same way as already known carriages, can be mounted so as to be displaceable within a rail or requires reduced space.

Separation elements connected to the carriage shall advantageously be movable into desired positions, for example into a stacked arrangement.

It shall further be possible to use the carriage universally for any desired separation devices, especially for individual separation elements, sliding stacking walls and folding sliding walls, which are to be moved more advantageously.

This object is achieved with a carriage and a separation device, which comprise the features defined in claims 1 and 9. Advantageous embodiments of the invention are defined in further claims.

The carriage provided for a separation device comprises a carriage body used to hold a separation element, which carriage body holds at least two running wheels, which can move on a rail, and also comprises a drive device comprising at least an electric motor and a gearing, which drive device is coupled to a first drive element, by means of which force can be directly or indirectly transferred to the rail and the carriage can be driven.

According to the invention the drive device is coupled to at least a second drive element, by means of which the rotatably held separation element can be driven, in particular rotated.

The drive device thus allows on the one hand the driving of the carriage within the rail and on the other hand the driving of the separation element with only one motor and only one gearing. The inventive carriage thus allows at least one separation element to be displaced optionally along a rail. At the same time the carriage allows the separation element to be optionally rotated. As only one motor is used with only one gearing, the carriage can be fully integrated into the rail and does not require more space than known carriages.

By means of the inventive carriage, separation elements can optionally be displaced and rotated without manual intervention or a corresponding rail system being required. A separation element can thus optionally be used as a sliding door and/or as a swivel door. Separation elements equipped according to the invention can for example be moved out of a parking area and joined together to form a separating wall without requiring an expensive rail system. Furthermore, the separation elements can be stacked at any desired position, for example in the parking area or also in the middle area of the rail. For this purpose a first separation element is moved to a parking position and rotated there into a position perpendicular to the rail. The rotation process can thereby already be started upon approaching the parking position, thus allowing a plurality of separation elements to quickly approach one another.

It is particularly advantageous to use the inventive carriage for folding sliding walls, in which a plurality of separation elements are connected to one another in a jointed way. In order to ensure that the processes for opening and closing the folding sliding wall run optimally, the drive devices of the individual carriages are correspondingly programmed or controlled. Wireless or wire-bound transmission of control signals is possible for example via the power supply lines, as described in [4], EP 1 657 393 A1. Optical, electrical and mechanical sensors and switches can thereby also be used, of which the signals are considered by an associated control program, in order to avoid collisions for example.

It is particularly advantageous that inventive carriages can also be used for separation elements which are provided with solar cells. These separation elements can be displaced along a rail and rotated in order to follow the progression of the sun and to constantly achieve an optimal angle of incident radiation. The electrical energy output by solar cells is preferably stored in an accumulator, which is provided within the inventive carriage. The inclusion of an accumulator is also particularly advantageous in conventional carriages.

A planet gear is preferably used as a gearing, whereby said planet gear comprises an input shaft coupled to the electric motor, an output shaft and a gearing housing coupled to the input shaft and to the output shaft. According to the invention the input shaft, the output shaft and the gearing housing are mounted so as to be rotatable in the carriage, whereby one of the drive elements is coupled to the gearing housing and the other drive element is coupled to the output shaft. It is in principle also possible to couple one of said drive elements or a further drive element to the input shaft. This is the case in particular when a further gearing is integrated within the motor.

The main structure of a planet gear is shown and described for example at http://de.wikepedia.org/wiki/Planetengetriebe. Planet gears typically comprise a planet carrier rotatable about an axis of rotation, having at least one toothed planet wheel arranged on the planet carrier, said planet wheel being coupled on the one hand to a centrally arranged, toothed sun wheel and on the other hand to a hollow wheel having an inner toothing. The planet wheels rotate around the sun wheel and thereby roll on the inner toothing of the hollow wheel. If the hollow wheel is held stationary, a certain number of rotations of the planet wheels and thus a corresponding number of rotations of the sun wheel arise with each rotation of the planet carrier. If the output shaft is held stationary with the sun wheel, the hollow wheel rotates on the other hand.

According to the invention the planet gear is installed and mounted such that all parts are mounted so that they can rotate. The hollow wheel and the output shaft are thus driven by the drive motor and the input shaft and are each equipped with a preferably toothed first or second drive element.

The input shaft or the output shaft can thereby be coupled to the planet wheels or the carrier thereof or to the sun wheel. The hollow wheel is fixedly connected to the housing of the planet gear, which thus rotates at the same angular speed as the hollow wheel. The rotation axes of the input shaft, the output shaft and the gearing housing preferably extend coaxially with each other, meaning that the drive device can have an extraordinarily compact structure.

The drive device is preferably incorporated into the carriage such that the rotation axes of the output shaft and of the gearing housing are perpendicular to the main axis of the rail and preferably perpendicular or parallel to the rotation axes of the running wheels. The drive device can therefore be integrated into the carriage in a horizontal, longitudinal, transverse or vertical position. The drive elements can thereby effect in varied ways, directly or indirectly, the displacement and rotation of the separation element or the drive of the carriage.

Two conductor rails are preferably provided within the rail, which are contacted by electrical contacts provided laterally on the carriage or on top of the carriage. Furthermore the drive device can also be supplied by an accumulator integrated into the carriage.

In a further preferred embodiment a mounting shaft serving to hold a separation element is mounted so as to be rotatable in the carriage body and arranged parallel to the output shaft, said mounting shaft being coupled via a preferably toothed connection element to the second drive element. The mounting of the separation element is thus decoupled from the drive device, which merely causes the rotation of the separation element via the second drive element. However, it is also possible for the separation element to be connected to the output shaft in a direct, rotatable or fixed way.

If the separation element is fixedly connected to the output shaft, it is rotated together with the output shaft. If the separation element is connected in a rotatable way to the output shaft, said separation element is driven via further cog wheels.

However, the use of a separate mounting shaft, by means of which the separation element is held, has the advantage that the mounting shaft can be connected to a cog wheel or to a segment of a cog wheel, which is driven by the second drive element with the desired transmission ratio. Heavier separation elements are thereby also successfully rotated.

The separation elements of a sliding stacking wall can be moved into a parking area and rotated together or sequentially. It is thereby particularly advantageous for the separation elements, already after a relatively limited rotation, to be moved so far against one another until the carriages connect to one another. The opening of a folding sliding wall is therefore no longer limited by the previously usual travel speed into a parking area, but can instead be realised at a speed which is many times higher. The inventive solution can be used particularly advantageously in systems with separation elements made of glass, in which a minimal rotation is already sufficient to move separation elements against each other. The separation elements which have traveled towards one another form a stack, which can then be rotated in its entirety until the stack lies parallel against a wall.

The first drive elements provided for the displacement of the separation element can drive the carriage in various ways. The first drive element is preferably coupled to a coupling belt extending in parallel along the rail and connected thereto. The first drive element is in this case a cog wheel, which engages in the cog belt held stationary in the rail and thereby drives the carriage.

Alternatively, the first drive element can also be coupled directly or indirectly to the running wheels of the carriage, whereby the carriage is moved by the driving of the running wheels.

The carriage preferably comprises a local control unit, which controls the drive motor. In order to ensure that the desired drive element is moved in each case, at least one detent unit is preferably provided, which can lock the output shaft or the gearing housing. If the separation element is to be displaced but not rotated, the second drive element, which is preferably connected to the output shaft, is locked. If, on the other hand, no displacement and instead only a rotation of the separation element is desired, the first drive element, which is preferably connected to the gearing housing, is locked. In the first case (locking of the second drive element), the separation element is functionally a sliding element, e.g. a sliding door. In the second case (locking of the first drive element), the separation element is functionally a rotation element, e.g. a rotating door. By correspondingly controlling the at least one detent unit, the functions of the separation element can thus be changed as desired, whereby a combination of both functions is also possible.

When using the inventive carriages in a folding sliding wall, it is preferable for every second one of the separation elements, which are pivotally connected to one another, to be connected on the front side to an inventive carriage. The drive speed of each carriage is preferably set so that the opening angles between each two of the separation elements change at least approximately at the same speed during opening and closing of the folding sliding wall. If for example a folding sliding wall is provided with four separation elements and two inventive carriages, the drive motor of the first carriage, which covers twice the distance, rotates twice as quickly as the drive motor of the second carriage. The carriages are driven by the first drive elements at a corresponding speed in the rail, while the second drive elements bring about the rotation of the separation elements.

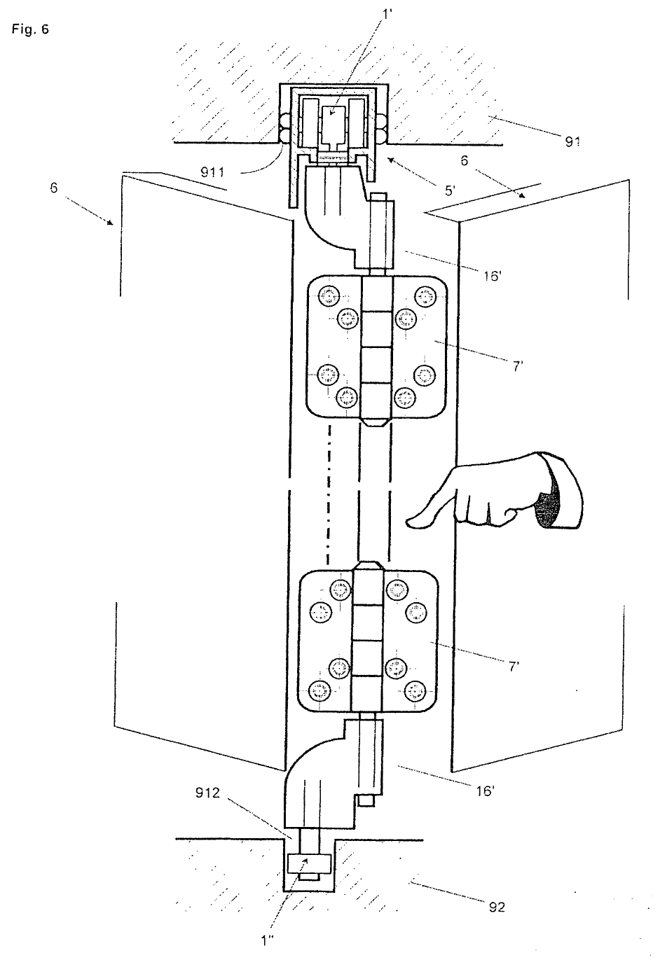

The separation elements can thereby be connected to each other by conventional hinge devices, as known from [3] and shown in FIG. 6. With these known hinge devices, both separation elements are rotated about the same axis so that the end faces of the separation elements abutting to the rotation axis open and close in the manner of pliers. If, for example, a small child gets into the rotation area of these end faces, considerable injuries may be caused.

In a preferred embodiment of the invention, therefore, each two of the separation elements of the folding sliding wall are connected to each other via a hinge device, whereby these hinge devices form a first rotation axis provided for the first separation element and a second rotation axis provided for the second separation element, said axes extending at a distance from each other and in parallel. Complete rotation of the end faces of the separation elements towards each other is thus avoided. In order to completely eliminate risks of injury and to avoid interference-causing gaps between the individual separation elements, hollow round profile segments are preferably provided on the end faces of the separation elements orientated against each other. Said round profile segments can be rotated towards each other at an at least approximately constant distance during opening and closing of the folding sliding wall. A hazardous pliers movement is thus avoided.

In a preferred embodiment of the inventive hinge device, preferably C-shaped mounting profiles are provided on the end faces of the separation elements orientated against each other, whereby on the lower sides and upper sides of said C-shaped mounting profiles two mounting blocks of a first or second hinge unit are mounted. Said mounting blocks are held so as to be rotatable by means of a connecting plate coaxially with the associated rotation axis. The mounting blocks preferably comprise pinion segments engaging in each other, through which it is ensured that the two separation elements are rotated by the same amount. It is particularly advantageous for the mounting blocks to be assembled by means of sliding blocks, which are introduced into the C-shaped mounting profiles and tightened.

The separation elements are preferably held on their upper side, preferably close to an end face, so that rotation takes place about an end face, which remains constantly below the rail. The separation element can be guided on the lower side in a guide rail incorporated for example into the base. In preferred embodiments the separation element is held on the lower side and on the upper side by an inventive carriage and moved by a drive device. The carriages are synchronously displaced in the rails so that they constantly remain vertically. For this purpose the local control units of the carriages can preferably communicate with one another. Alternatively, only one local control unit is used for two carriages connected to a separation element. Communication lines and/or control lines are laid preferably on the end faces of the separation elements, preferably in the hollow profile segments. By using two inventive carriages, separation elements, which can generally be made of any desired materials such as glass, metal or wood, can be rotated more easily.

The invention is explained in greater detail below by reference to the drawings, in which:

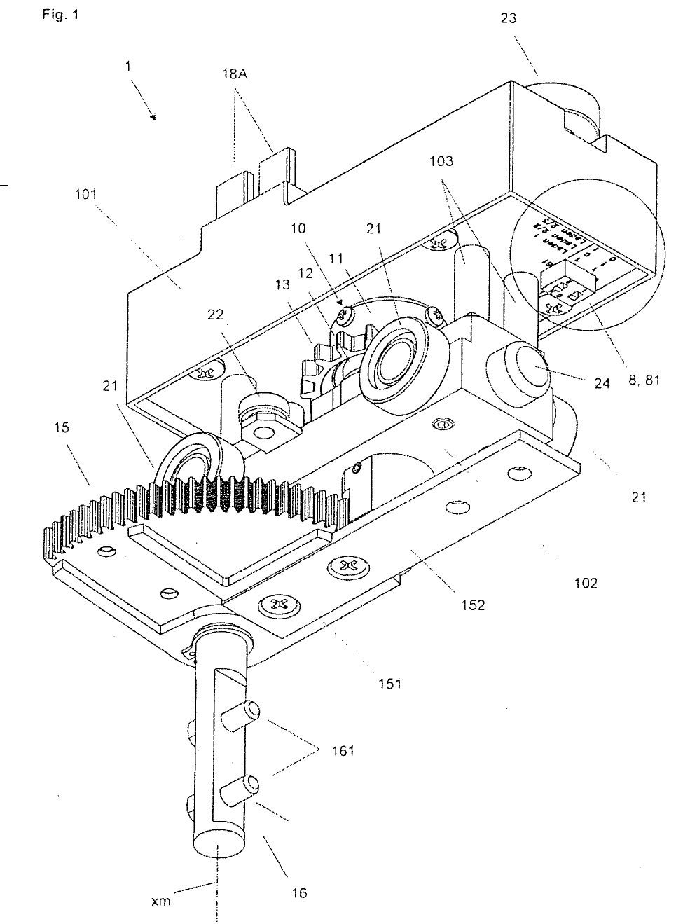

FIG. 1 shows the inventive carriage 1 in a preferred embodiment;

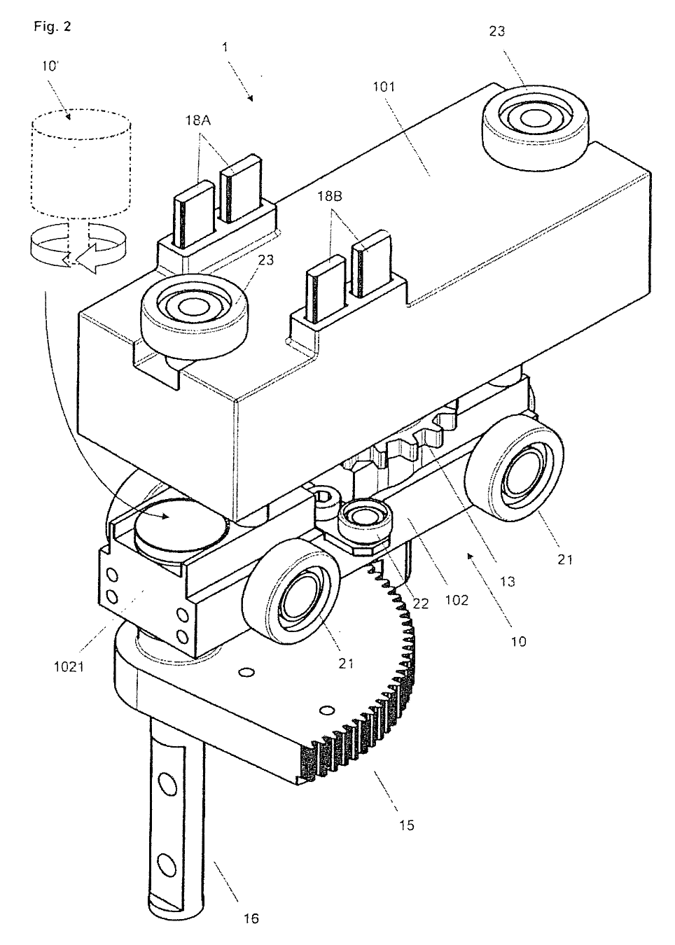

FIG. 2 the carriage 1 of FIG. 1 in a spatial illustration seen from above;

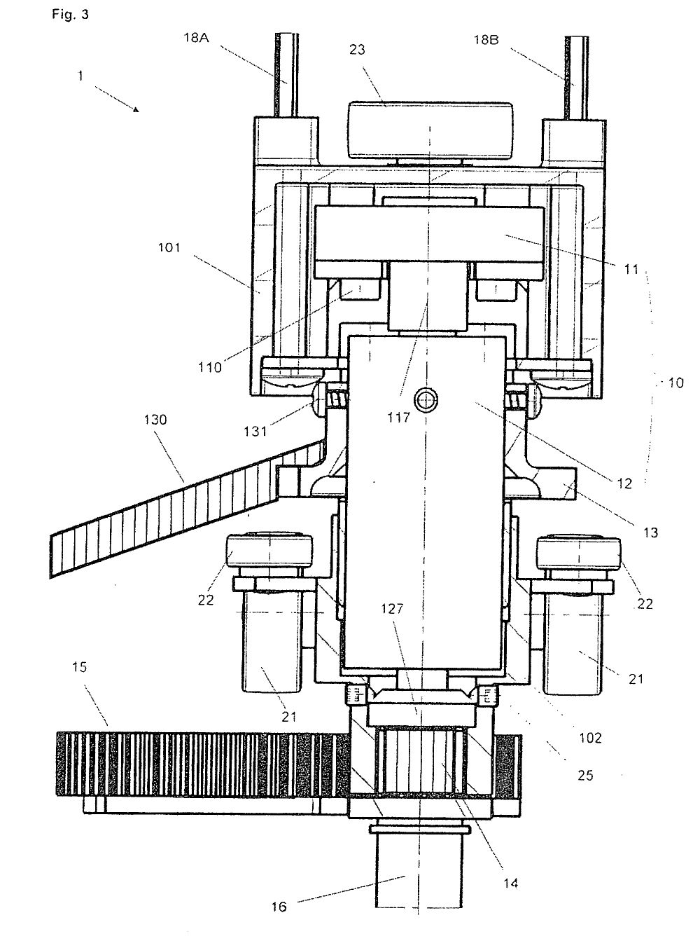

FIG. 3 the carriage 1 of FIG. 1 in a sectional illustration, which shows the drive device with the motor 11 and the gearing 12;

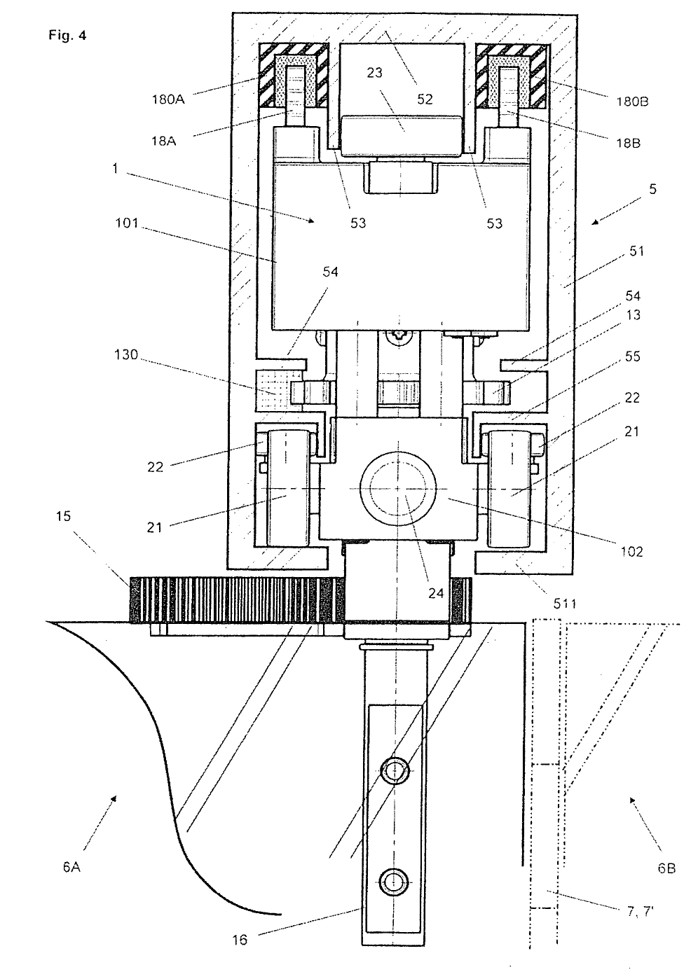

FIG. 4 the carriage 1 of FIG. 1 introduced into a rail 5;

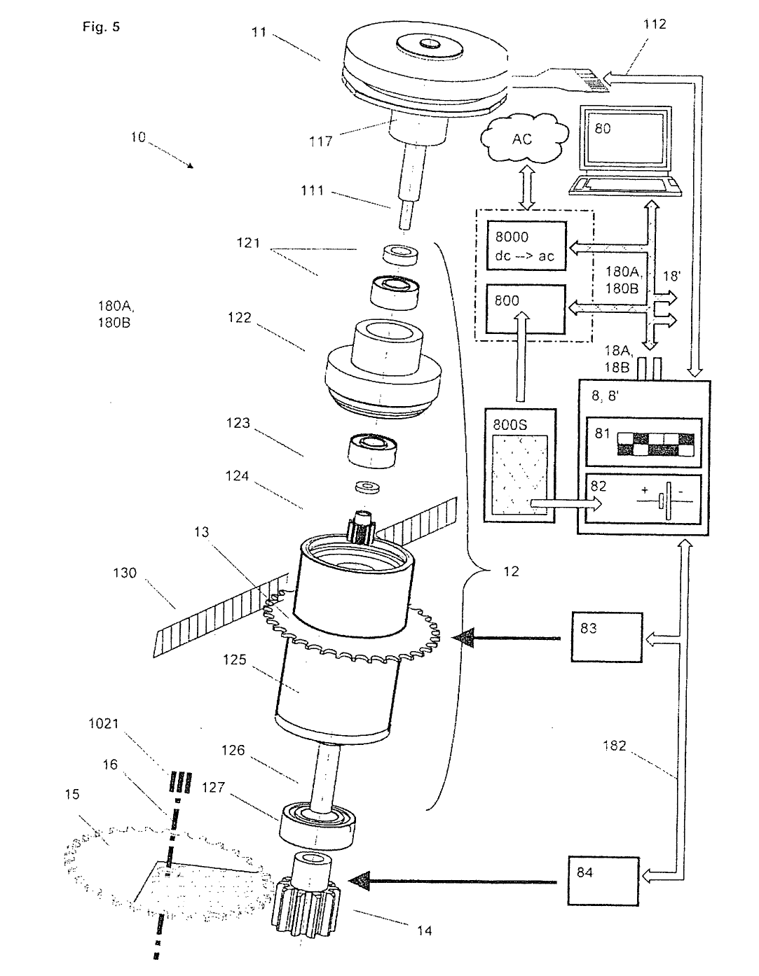

FIG. 5 the preferably used drive device 10 of the carriage 1 in an exploded illustration and a local control unit 8 provided in the carriage 1, an external central control unit 80 and a conventional power supply unit and a power supply unit 800 based upon solar energy;

FIG. 6 elements of the folding sliding wall known from [3] with a known hinge device 7′;

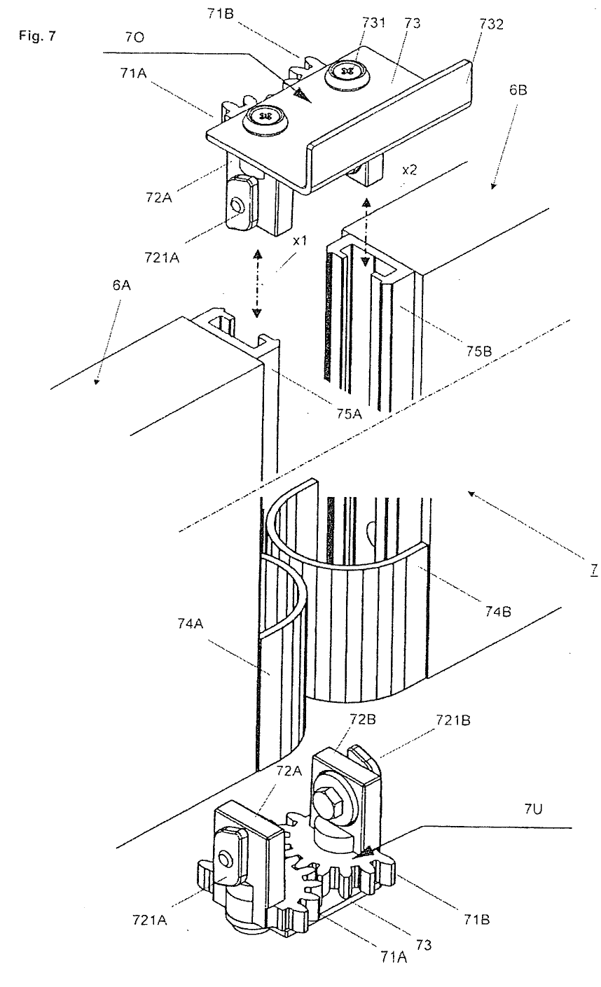

FIG. 7 an inventive hinge device 7 for a folding sliding wall 60;

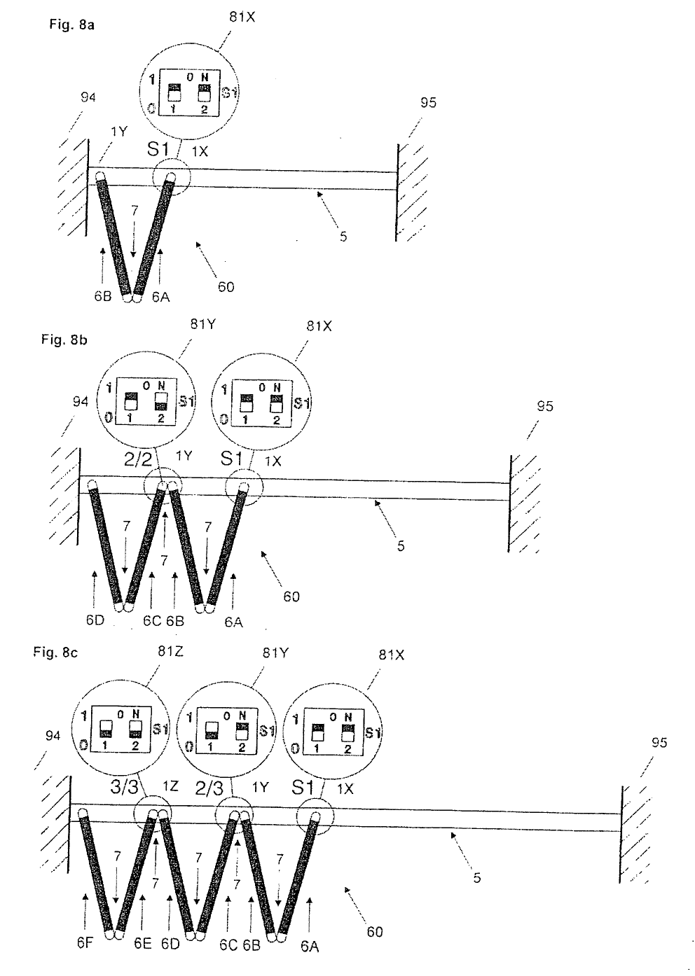

FIG. 8a an inventive folding sliding wall 60 with two separation elements 6A, 6B;

FIG. 8b an inventive folding sliding wall 60 with four separation elements 6A, 6B, 6C, 6D; and

FIG. 8c an inventive a folding sliding wall 60 with six separation elements 6A, 6B, 6C, 6D, 6E, 6F.

FIGS. 1, 2, 3 and 4 show an inventive carriage 1 in different spatial illustrations. FIG. 1 shows the carriage 1 laterally from below. FIG. 2 shows the carriage laterally from above. FIG. 3 shows a cross-section through the carriage 1 at the height of the drive device 10. In FIG. 4 the carriage 1 is connected to a separation element 6A and guided in a rail 5.

The carriage 1 comprises a carriage body 102, on both sides of which two running wheels 21 and one guide wheel 22 are mounted so as to be rotatable. Furthermore a mounting shaft 16 is mounted so as to be rotatable in a bearing block 1021 in the carriage body 102 (see FIG. 2), whereby said mounting shaft 16 can be connected to a separation element 6 (see FIG. 4). A buffer element 24 is inserted into the end face of the carriage body 201, which buffer element 24 cushions the impact of the carriage 1 on a further body, an end stop or a further carriage 1.

As described so far, the carriage 1 can be inserted with the carriage body 102, the running wheels 21, the guide wheels 22 and the mounting shaft 16 into the rail 5 shown in FIG. 4 and be manually moved.

According to the invention the carriage 1 additionally comprises a drive device 10, by means of which a first drive element 13, namely a cog wheel, is driven. Said cog wheel can engage in a cog belt 130 installed in the rail 5 and drive the carriage 1 along the rail 5, as shown in FIGS. 3, 4 and 5.

Furthermore, the drive device 10 drives a second drive element 14, likewise a cog wheel, which engages in a toothed connection element 15, a segment of a cog wheel, connected to the mounting shaft 16, and can rotate it about the rotation axis xm of the mounting shaft 16.

For the purpose of mounting the drive device 10, the carriage 1 is provided with an additional module 101, which is rigidly connected to the carriage body 102 via connection elements 103. The additional module 103, in which the drive device 10 is held on one side, also contains the elements of the electrical system, including the control unit 8, which can be programmed by means of a switch bank 81, and sliding contacts 18A, 18B, by means of which conductor rails 180A, 180B laid in the rail 5 can be contacted (see FIG. 4).

The drive device 10, which is shown in an exploded view in FIG. 5 and incorporated into the carriage 1 in FIG. 3, comprises an electric motor, for example of the type “EC 32 FLAT” of MAXON MOTOR AG, the drive shaft of which is coupled to a differential gear or planet gear, for example of the type “GP 22 A” of the same manufacturer.

FIG. 2 further shows a second drive device 10′, which can likewise be integrated into the carriage 1. Insofar as the second drive device 10′ is integrated, the first drive device can be equipped with only one drive element 13, which serves for example for engagement in the cog belt 130 and for driving the carriage 1. The drive shaft of the second drive device 10′ can be directly coupled to the mounting shaft 16. As shown in FIG. 2, the two drive devices 10, 10′ can be mounted one beside the other with drive shafts preferably arranged parallel to each other.

It can be seen from FIGS. 3 and 5 that the electric motor 11 comprises a connection cable 112 and a motor body 117, in which the drive shaft 111 is mounted so as to be rotatable and which is mounted in the additional module 101 by means of mounting screws 110. The drive shaft 111, which simultaneously forms the input shaft of the planet gear 12, is mounted so as to be rotatable in the housing head 122 of the planet gear 12 by means of first and second bearing elements 121, 123 and is connected to a cog wheel 124. The cog wheel 124 is for example a sun wheel, which drives planet wheels (not shown), which are arranged so as to be rotatable on a planet carrier, which is connected to the output shaft 126 mounted so as to be rotatable in the planet gear 12. Furthermore, a hollow wheel is driven by the planet wheels, which hollow wheel is connected to the housing 125 of the planet gear 12 and rotates synchronously with it. The output shaft 126 of the planet gear is mounted so as to be rotatable by means of a third bearing element 127, which is fixed in the carriage body 102 by means of fixing screws 25. The planet gear 12 can thus be rotated, including the input shaft 111, the output shaft 126 and the gearing housing 125, about a common drive axis ax. In this embodiment of the carriage 1, said drive axis ax is perpendicular to the main axis of the rail 5 and perpendicular to the rotation axis lx of the running wheels 21 and also parallel to the rotation axis mx of the mounting shaft 16. It can be clearly seen in FIG. 3 that the gearing housing 125 of the planet gear 12 connected to the first drive element 13 (shown in a sectional illustration) is merely held by the input shaft 111 and the output shaft 126, which for their part are mounted so as to be rotatable.

It is understood that other drive devices with other motors and otherwise constructed differential and planet gears can also be used, which can be operated with any desired movement sequence, including kinematic reversal. For example the output shaft can also be connected to a sun wheel. Furthermore, multi-stage gearing, e.g. with a plurality of planet carriers and sun wheels, can be used. It is merely necessary that from the gearing, which is used, two torques can be transferred to a first and to a second drive element 13, 14.

In the embodiment shown, the first drive element 13, a cog wheel engaging in the cog belt 130, is connected to the gearing housing 125 by means of mounting screws 131. The second drive element 14 is connected to the output shaft 126 of the planet gear 12 and is coupled to a toothed connection element 15, which is a quarter segment of a cog wheel in the embodiment shown. The connection element 15 is connected or connectable to a separation element 6A (see FIG. 4) by means of a mounting strip 152 inserted into a receiving element 151. The diameters of the second drive element 14 and of the connection element 15 are selected so that the installed separation element 6A can be driven with high torque. The segment cutout of the connection element 15 is selected corresponding to the desired angle of rotation. In many applications, a rotation angle of 90° suffices, whereby this allows the installed separation element 6 to be orientated perpendicular to the axis of the rail 5, for example to be parked parallel to a wall. If necessary, however, the connection element 15 can also be a complete cog wheel.

FIG. 5 further shows the control unit 8 of the carriage 1 with the preferably provided switch bank 81, of which the switches are set corresponding to the desired speed of the carriage 1 (see also FIGS. 8a, 8b and 8c). The operating current is preferably supplied to the carriage 1 from an external power supply unit 800 via the conductor rails 180A, 180B shown in FIG. 4 and the sliding contacts 18A, 18B. By means of the conductor rails 180A, 180B, data, operating data, status data and control signals can also be transmitted between the local control unit 8 in the carriage 1 and a central control unit 80. It is thereby possible to individually control each carriage 1, which is connected to a folding sliding wall 60 or only to a separation element 6. This is particularly advantageous for larger installations, in department stores or in façade structures, in which weather protection, sun protection, harnessing of solar energy or aesthetic effects are to be achieved using the separation elements 6. The separation elements 6 can thereby be moved into the configuration desired by the architect. As mentioned, the separation elements 6 can also be moved and rotated as necessary in dependence upon the weather and solar radiation. It is particularly advantageous that the drive devices 10 of the separation elements 6 can also be supplied by solar cells 800S, which are mounted on the separation elements 6 or are installed in a stationary manner, for example on a façade of a building.

An accumulator 82, possibly a capacitor with a high capacity, is preferably integrated into the carriage 1, preferably into the additional module 101, particularly in case of separation elements 6, of which the carriages 1 are supplied by solar cells 800S. Autonomous operation of the carriage 1 is thereby guaranteed. Furthermore, mixed operation is possible, wherein the external power supply unit 800 is only used if necessary, for example in order to initialise the separation elements 6 or to move them into a position provided for energy consumption.

Systems with a plurality of separation elements 6, which are equipped with solar cells 800S, can be used to extract energy and feed it back into the public power supply network. For this, a current regulating unit 8000 is used, which converts a direct current into an alternating current that can be supplied to the public alternating current network. Devices of this type are known for example from [6], DE 196 38 880 C1. It is thereby possible, particularly in the case of façade installations, to generate a considerable share of the energy required in a building through the separation elements 6 or solar cells 800S installed on the façades.

In a preferred embodiment the conductor rails 180A, 180B are used to transfer the current which is output by the mobile or stationary solar cells 800S. A direct current generated by the solar cells 800S, or an alternating current derived from it, is preferably transferred via the conductor rails 180A, 180B to the current regulating unit 8000 or to further consumers, possibly drive devices. If solar cells 800S (or a solar panel) are fixedly installed on a façade of a building, the conductor rails 180A, 180B provided for the separation elements 6 are simultaneously used as a bus bar for the collection and transfer of the solar energy for feedback into the alternating current network and/or for driving the separation elements 6. It is thereby possible to separate the extraction and feedback of solar energy, which takes place via the conductor rails 180A, 180B, completely from the power supply of the separation elements 6. Alternatively, the solar energy can be connected if the necessary requirements can be covered.

The transfer of the solar energy preferably takes place at intervals, in which the separation elements 6 are not being driven. It is also possible for a direct current to be supplied to the conductor rails 180A, 180B from the solar cells, while for the drive of the separation elements 6 an alternating voltage is supplied to the conductor rails 180A, 180B by the power supply unit 800. Said alternating voltage is superimposed on the direct voltage output by the solar cells 800S.

On the other hand direct voltages preferably of equal magnitude are supplied from both the power supply unit 800 and from the solar cells 8005 to the conductor rails 180A, 180B. It is then checked through the local control unit and central control unit 8 and 80 respectively whether the solar energy is sufficient for the supply of the separation elements 6.

One or more threshold values can thereby be monitored by the local control unit and central control unit 8 and 80 respectively. If the voltage output by the mobile and/or stationary solar cells 800S exceeds for example a first threshold value, the power supply unit 800 is switched off and the system continues to be operated only with solar energy. If the voltage output by the mobile or stationary solar cells 8005 exceeds a second threshold value, the current regulating unit 8000 additionally feeds energy back into the alternating current network. A communication is preferably provided between the central control unit and the local control units 8, 80 for switching the power supply unit 8000 and the solar cells 8005 on and off. If solar cells 800S are installed in a stationary way, they are preferably provided with a local control unit 8′, for example a single chip processor. For the connection of stationary solar cells 800S, the conductor rails 180A, 180B preferably comprise connections 18′ equipped with plug connectors (shown schematically in FIG. 5), which are taken out of the rail 5 or are accessible therein.

The transmission of control signals can be realised in any desired way. For example, control signals are transmitted by radio, optically or by means of radio waves, or cable-bound via electric cables, in particular the conductor rails 180A, 180B, as described in [4]. Signals can thereby be transmitted for example according to the time multiplexing method or the frequency multiplexing method or through switching on and off of the direct voltage.

The transmission of solar power via the conductor rails 180A, 180B is realised particularly advantageously in systems in which the inventive carriage 1 is used, but can also be advantageously used when using other carriages and drive systems. As mentioned, the solar power can be fed into an alternating current network and/or be provided for the driving of further carriages or separation elements, which do not receive adequate solar energy, for example on account of disadvantageous solar radiation.

It is further shown in FIG. 5 that two preferably provided detent units 83, 84 can be controlled by means of the control unit 8 via control lines 182, whereby the first or the second drive element 13, 14 can be blocked or inhibited by said detent units 83, 84. By actuating the first detent unit 83, the first drive element 13, which serves for displacement of the carriage 1 within the rail 5, can be locked. In this case only the second drive element 14, which can rotate the separation element 6 held, is actuated. By actuating the second detent unit 84, the second drive element 14 can be locked, after which the separation element 6 held can only be displaced but not rotated. The separation element 6 can thereby be displaced and/or rotated as desired by means of the local or central control unit 8, 80. The two detent units 83, may for example be designed as two-part brakes, which loosely surround the gearing housing 125 and the output shaft 126 or the second drive element 14 and, if necessary, are tightened using an actuator. In order to avoid mechanical wear, the drive motor 11 can also be stopped when changing the operating states of the detent units 83, 84. In this case it is possible for the gearing housing 125 or the second drive element 14 to also be held in a shape-locking way.

In FIG. 4, the carriage 1 is inserted into the U-profile-shaped rail 5, which comprises a middle element 52 and two side elements 51, which are each provided with guiding and mounting ribs 53, 54, 55, which project into the cross-section of the rail. Two first ribs 53 are provided on the middle element 52, which first ribs 53 each enclose, together with the associated side element 51, a space in which one of the conductor rails 180A, 180B is mounted. Two guide wheels 23 preferably provided on the upper side of the carriage 1 or on the additional module 101 are guided between the two first ribs 53 (FIG. 2). Said guide wheels 23 hold the carriage 1 in vertical position. Through the further ribs 54 and 55 provided on the side elements 51 of the rail 5, a respective area is formed for receiving the cog belt 130, which is installed on only one of the side elements 51. The lowermost ribs 55 form a downwardly orientated L-shaped profile, within which the guide wheels 22 provided laterally on the carriage 1 are guided. Through the lateral and upper guide wheels 22, 23, it is thus ensured that the running wheels 21 can roll precisely in the track and in the correct position on the foot elements 511, which are provided at the lower ends of the side elements 51 and are orientated against each other. The stabilisation of the carriage 1 in the rail 5 by arranging corresponding running and guide elements 22, 23 is preferably provided in dependence upon the load of the separation element and also in dependence upon the use of a running and/or guiding device on the opposite side of the separation element 6. In principle, a carriage can be provided which has a running wheel 21 only on one side. Carriages are often used which have two running wheels 21 on one side, so that branches can be used within a rail system. Inventive carriages 1 can therefore also be used for complex rail systems.

The conductor rails 180A, 180B can alternatively also be arranged on the side elements 51 of the rail 5. It is likewise possible to arrange the cog belt 130 on the middle element 52 of the rail 5. This can be useful if the drive axis ax of the drive devices 10 is orientated parallel to the rotation axis lx of the running wheels 21. In this case it is also possible to couple the input shaft 111, the output shaft 126 or the rotatably mounted gearing housing 125 via cog wheels or cog belts to one of the running wheels 21 and to drive it. In this case the mounting of a cog belt 130 is unnecessary, which can be advantageous particularly in façade construction.

FIG. 4 further schematically shows that the inventive carriage 1 can be used particularly advantageously for driving folding sliding walls 60, the elements 6A, 6B, . . . of which are to be displaced along the rail 5 and rotated, in order to open and close the folding sliding wall 60.

The individual separation elements 6A, 6B, . . . , can in this connection be provided with hinge devices 7′, as shown in [3], page 36, and below in FIG. 6. FIG. 6 shows a known carriage 1′, which is not provided with a drive device and which is guided in a known rail 5′ mounted in a recess 911 in a ceiling 91. On the lower side of the separation elements 6A, 6B, a guiding device 1′ is provided with a running roller, which is guided within a recess 921 provided in the base 92, and thereby receives the torque caused by the separation elements 6A, 6B, so that the upper carriage 1′ is only subject to a tensile load. The carriage 1′ and the guide device 1″ are connected via a mounting shaft 16′ to the known hinge devices 7′. In the case of these known hinge devices, both separation elements 6A, 6B are rotated about this same axis so that the end faces of the separation elements 6A, 6B connecting to the rotation axis open and close like pliers. The problems thereby arising have already been described.

According to the invention a hinge device 7 is used, which is shown by way of example in FIG. 7. This hinge device 7 forms a first rotation axis xl provided for the first separation element 6A and a second rotation axis x2 provided for the second separation element 6B. Said rotation axes x1, x2 extend at a distance from each other and parallel to each other in the region of the end faces of the separation elements facing each other. Complete rotation of the end faces of the separation elements 6A, 6B against each other is thus avoided. In order to completely eliminate risks of injury and to avoid interference-causing gaps between the individual separation elements 6A, 6B, hollow round profile segments 74A, 74B are provided on the end faces of the separation elements 6A, 6B orientated against each other, whereby said hollow round profile segments 74A, 74B are rotated against each other at an at least approximately constant distance from each other upon opening and closing the folding sliding wall. It is thus no longer possible for a person to put his hand for example between the end faces of the separation elements 6A, 6B and to thereby be injured. Flooding between the round profile segments 74A, 74B can additionally be closed off by elastic sealing elements.

In the preferred embodiment of the hinge device of FIG. 7, C-shaped mounting profiles 75A, 75B are provided on the end faces of the separation elements 6A, 6B orientated against each other, said C-shaped mounting profiles 75A, 75B extending over the entire length of the end faces. On the lower side and the upper sides of the C-shaped profiles 75A, 75B, two mounting blocks 72A, 72B in each case are mounted by means of sliding blocks 721A, 721B, which are introduced into the C-shaped profiles 75A, 75B and tightened. This type of mounting is particularly simple and can be carried out with few hand grips. The mounting blocks 72A, 72B are mounted by means of mounting screws 731 with a connection plate 73 so as to be rotatable at a mutual distance. The distance is selected so that pinion segments 71A, 71B connected to the mounting blocks 72A, 72B can engage in each other. It is ensured through the pinion segments 71A, 71B that a rotation of the first mounting block 72A results in an equal rotation of the second mounting block 72B. Through this measure, even opening and closing of the folding sliding wall 60 is guaranteed. The connection plate 73 further comprises a stop 732, which limits the deflection of the hinge 7 and ensures that the separation elements 6 can only be folded in one direction.

FIGS. 8a, 8b and 8c show inventive folding sliding walls 60 with two, four and six separation elements 6A, 6B; 6C, 6D; 6E, 6F, which are connected to one another by means of inventive hinge devices 7 and are held and driven by means of one, two or three inventive carriages 1X; 1Y; 1Z, which can be moved along a rail 5 between a first and a second wall 94, 95. In case of each folding sliding wall 60, beginning with the first separation element 6A, which is provided on the front side with a carriage 1X, every further second separation element 6C and 6E is also provided on the front side with a further inventive carriage 1Y; 1Z.

The switch bank 81X; 81Y; 81Z of each carriage 1X; 1Y; 1Z is also shown, by means of which the travel speeds can be individually adjusted. It can thereby be seen that in the case of the switch bank 81X of the first carriage 1X both switches are set to “1”, which is why the carriage 1X travels at maximum speed upon actuation. In FIG. 8b the switches are set such that the second carriage 1Y only travels at half the speed of the first carriage 1X, which must cover twice the distance. In FIG. 8C the travel speeds are reduced by a third from carriage to carriage 1X; 1Y; 1Z corresponding to the distances to be covered.

In the embodiments of FIGS. 8a, 8b and 8c, the last separation element 6B, 6D, 6F of the folding sliding wall 60 is fixed to the first wall 94 in a jointed way. It can be advantageous, however, in various applications if the whole folding sliding wall 60 can be moved in the folded or in at least partially open state. For this purpose the last separation element 6B, 6D; or 6F is also preferably provided with a carriage 1. The folding sliding wall 60 can thereby be displaced as a closed stack. It is further preferably provided that the carriages 1X; 1Y; 1Z can also be individually controlled so that a folding assembly can be moved to a certain point and opened there.

As mentioned, two drive devices 10, 10′ can also be integrated into the carriage 1, of which the first serves for the driving of the carriage 1 within the rail 5 and the second for the driving or the rotation of the separation element 6. In this case both drive devices 10, 10′ are correspondingly controlled by the control unit, meaning that the detent devices 83 and 84 can be omitted.

### LITERATURE

[1] EP 1 916 370 A1
[2] WO 97/49885
[3] Product catalogue of HAWA A G, “Baubeschläge für Schiebeläden”, [“Fittings for sliding shutters”], 2006
[4] EP 1 657 393 A1
[5] http://de.wikipedia.org/wiki/Planetengetriebe
[6] DE 196 38 880 C1

### List of Reference Numerals:

| | |
|---|---|
| 1 | carriage |
| 1′ | known carriage |
| 1″ | known guiding device |
| 1X, 1Y, 1Z, . . . | carriages of the folding sliding wall |
| 10 | drive device |
| 101 | additional module |
| 102 | carriage body |
| 1021 | bearing block |
| 103 | connection elements |
| 11 | electric motor |
| 110 | mounting screws for the electric motor |
| 111 | drive shaft |
| 112 | connection cable |
| 117 | motor body |
| 12 | planet gear |
| 121 | first bearing elements |
| 122 | housing head |
| 123 | second bearing elements |
| 124 | drive wheel |
| 125 | gearing housing |
| 126 | output shaft |
| 127 | third bearing elements |
| 13 | first toothed drive element |
| 130 | cog belt |
| 131 | mounting screws for the first drive element |
| 14 | second toothed drive element |
| 15 | toothed connection element |
| 151 | receiving element for mounting strip |
| 152 | mounting strip |
| 16 | mounting shaft |
| 16′ | mounting shaft of the known hinge device |
| 161 | mounting elements |
| 18A, 18B | sliding contacts |
| 180A, 180B | conductor rails |
| 182 | control line |
| 21 | running wheels |
| 22 | lateral guide wheels |
| 23 | upper guide wheels |
| 24 | buffer |
| 25 | fixing screws |
| 5 | rail, preferably U-profile-shaped |
| 5′ | known rail |
| 51 | side elements of the rail 5 |
| 52 | foot elements on the side elements 51 |
| 52 | middle element of the rail 5 |
| 53, 54, 55 | guiding and mounting ribs |
| 6; 6A, 6B, . . . | separation element(s) |
| 60 | folding sliding wall |
| 7 | hinge device |
| 7′ | known hinge device |
| 7O, 7U | upper and lower hinge unit |
| 71A, 71B | pinion segments |
| 72A, 72B | mounting blocks |
| 721A, 721B | sliding blocks |
| 73 | connection plate |
| 731 | mounting screws |
| 732 | stop |
| 74A, 74B | round profile segments |
| 75A, 75B | C-shaped profiles mounted on the separation elements |
| 8 | local control unit |
| 80 | central control unit |
| 800 | external power supply unit |
| 81 | switch bank with control switches |
| 82 | accumulator |
| 83, 84 | first and second detent unit |
| 91 | ceiling |
| 911 | recess in the ceiling |
| 92 | base |
| 921 | recess in the base |
| 94 | first wall |
| 95 | second wall |

1. Carriage for a separation device with a carriage body serving to hold a separation element, which carriage body comprises at least one running wheel which can be moved on a rail, and with a drive device comprising at least an electric motor and a gearing, which drive device is coupled to a first drive element, by means of which a force can be transferred directly or indirectly to the rail and the carriage can be driven, wherein the drive device is coupled to at least one second drive element, by means of which the rotatably held separation element can be driven.

2. Carriage according to claim 1, wherein the gearing is a differential gear or a planet gear, which comprises an input shaft coupled to the electric motor, an output shaft and a gearing housing coupled to the input shaft and the output shaft, whereby
a) one of the drive elements is coupled to the rotatably mounted gearing housing and
b) the other one of the drive elements is coupled to the output shaft mounted so as to be rotatable in the carriage body with the aid of a bearing element.

3. Carriage according to claim 1, wherein the planet gear comprises planet wheels coupled to the input shaft or the output shaft, which planet wheels drive a sun wheel coupled to the output shaft or the input shaft and a hollow wheel connected to the gearing housing, whereby the rotation axes of the input shaft, the output shaft and the gearing housing extend coaxially with each other.

4. Carriage according to claim 1, wherein the rotation axes of the output shaft and of the gearing housing are perpendicular to the rotation axes of the running wheels and/or perpendicular to the main axis of the rail, and in that the carriage is provided with electrical contacts, by means of which conductor rails can be contacted, which are connected to the rail and are arranged parallel thereto.

5. Carriage according to claim 1, wherein in the carriage body a mounting shaft, which is serving to hold a separation element, is mounted so as to be rotatable and is arranged parallel to the output shaft and coupled via a connection element to the second drive element, and/or in that the first and the second drive element and the connection element, which is a segment only, comprise toothing.

6. Carriage according to claim 1, wherein
a) the first drive element can be coupled to a coupling belt extending in parallel along the rail and connected thereto, or
b) the first drive element is coupled to at least one of the running wheels.

7. Carriage according to claim 1, wherein a control unit, which may be coupled to a central control unit, is provided,
a) by means of which control unit the first and/or the second drive device can be controlled and/or
b) by means of which control unit a first and/or a second detent unit can be controlled, by means of which the first or second drive element of the first drive device can be locked.

8. Separation device with at least one carriage according to claim 1 guided in a rail wherein the carriage
a) is connected to a separation element provided with solar cells, which separation element can be moved along the rail and rotated, so that a desired incident radiation angle can be adjusted relative to the incident solar radiation; or
b) is connected to a separation element of a sliding stacking wall, which can be rotated by a desired angle in particular in the parking area; or
c) can be connected to a separation element of a folding sliding wall, which can be rotated during the travel.

9. Separation device according to claim 8, wherein conductor rails, which are connected to a power supply unit, are installed in the rail, to which conductor rails the drive device of the carriage is coupled via sliding contacts and/or to which conductor rails solar cells, which are stationary or connected to the separation elements, are connected directly or via the sliding contacts, from which solar cells electrical energy can be transferred via the conductor rails to further separation elements or to a current regulating unit, which feeds the supplied energy into a further current network.

10. Separation device according to claim 8, wherein the U-profile-shaped rail comprises a middle element and two side elements, which are each provided with guiding and mounting ribs, by means of which within the rail the conductor rails are held on the middle element and the cog belt is held on one of the side elements, and along which guide wheels, which are connected to the carriage body of the carriage, can be guided, and in that the side elements are provided with foot elements elbowed against each other, on which the at least one running wheel can roll, and/or in that the at least one separation element is guided on the lower side in a guide rail.

11. Separation device according to claim 8, wherein every second one of the separation elements of the folding sliding wall, which are pivotally connected to each other, is connected at one end to a carriage, whereby the drive speed of each carriage is adjusted so that the opening angles between each two of the separation elements change at least approximately at the same speed upon opening and closing of the folding sliding wall.

12. Separation device according to one of the claims 8, wherein two of the respective separation elements of the folding sliding wall are connected to each other via a hinge device, which forms a first rotation axis provided for the first separation element and a second rotation axis provided for the second separation element, said rotation axes being arranged at a distance from each other and extending parallel to each other.

13. Separation device according to claim 12, wherein C-shaped mounting profiles are provided on the end faces of the separation elements orientated against each other, on the lower and upper sides of which mounting profiles, by means of sliding blocks, two respective mounting blocks of a first or second hinge unit are provided, which are held by means of a connection plate so as to be rotatable coaxially with the associated rotation axis and comprise pinion segments engaging in each other.

14. Separation device according to claim 13, wherein hollow round profile segments are provided on the end faces of the separation elements orientated against each other, which round profile segments can be rotated at an at least approximately constant distance from each other when the folding sliding wall is opened and closed.

15. Separation device according to claim 8, wherein the transfer of direct current or alternating current, which can be transferred from a power supply unit and from stationary or mobile solar cells via the conductor rails, can be controlled by the central and at least one local control unit.
